(19) United States
(12) Patent Application Publication
(10) Pub. No.: US 2007/0221090 A1
(43) Pub. Date: Sep. 27, 2007

(54) Non-Aqueous Polar Ink Composition

(76) Inventors: Timm Deeg, Wachenheim (DE); Karin Staringer-Kohl, Birkenau (DE); Arno Wink, Eppelsheim (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/588,133

(22) PCT Filed: Mar. 9, 2005
(86) PCT No.: PCT/EP05/02503

§ 371 Date: Dec. 20, 2006

(30) Foreign Application Priority Data
Mar. 15, 2004 (DE) 10 2004 012 479.5

(51) Int. Cl. C09D 11/18

(52) U.S. Cl. 106/31.13

(57) ABSTRACT

The present invention relates to a nonaqeuous polar ink composition comprising a) 1-40 weight percent of at least one water-insoluble colorant, b) 50-98 weight percent of at least one polar solvent selected from the group comprising of glycols, glycol ethers, alcohols and mixtures thereof, c) 0.05-5 weight percent of at least one crosslinked polymer swellable in the polar solvent used, said polymer being selected from the group consisting of homo- and copolymers of acrylic acid or alkyl acrylates, crosslinked with polyalkenyl ethers, divinylglycol, allyl ethers of pentaerythrol, allyl ethers of sucrose or allyl ethers of propylene, and crosslinked homo- and copolymers of maleic anhydride-methyl vinyl ether, all weight percentages being based on the total weight of the ink composition, and the ink composition having a viscosity in a range of 30 to 6000 mPas, measured at 20° C. The nonaqeuous polar ink composition according to the present invention confers a soft feel of writing, remains writable without cap for a prolonged period, does not form drops at the tip and provides a waterfast script.

The invention relates to a non-waterborne writing ink for a writing implement, in particular for a ballpoint pen.

A ballpoint pen is expected
a) to confer a smooth feel of writing
b) to remain writable for a long period without cap, i.e. to be storable in the uncapped state for a prolonged period
c) not to form drops at the tip and
d) to provide a waterfast script.

Traditional ballpoint pens, filled with a solventborne paste, write slightly retardingly owing to their relatively high viscosity, form droplets, at the tip, but are not storable in the uncapped state for a prolonged period, and provide a waterfast script. The soft writing of such a ballpoint pen paste can be improved by distinctly reducing viscosity. This goal can be achieved by omitting, or distinctly reducing, the thickening fractions, such as resins or polymers, as described in EP 0 738 302 B1. The disadvantage is that a low-viscosity ink of this kind is increasingly prone to static leaking, i.e. to form drops at the tip when the pen is stored in the vertical position with the tip pointing down.

Waterborne inks for ballpoint pens are also known. However, these inks have the disadvantage that the water fraction, being extremely volatile, evaporates at the tip and leads to drying out, so that a closure cap is needed to prevent this problem. A further disadvantage is that such inks can only include water-soluble dyes, so that the script obtained is not completely waterfast. If, on the other hand, such ink includes pigments as colorants, the script does indeed become waterfast, but the risk of drying out at the tip becomes all the more greater.

There is accordingly, a need for a ballpoint pen ink that combines the advantages of conventional ball point pastes and waterborne inks without having their disadvantages.

This object is achieved by the embodiments characterized in the claims. More particularly, there is provided a nonaqueous polar ink composition comprising
a) 1-40 weight percent of at least one water-insoluble colorant,
b) 50-98 weight percent of at least one polar solvent selected from the group comprising of glycols, glycol ethers, alcohols and mixtures thereof,
c) 0.05-5 weight percent of at least one crosslinked polymer swellable in the polar solvent used, said polymer being selected from the group consisting of homo- and copolymers of acrylic acid or alkyl acrylates, crosslinked with polyalkenyl ethers, divinylglycol, allyl ethers or pentaerythrol, allyl ethers of sucrose of allyl ethers of propylene, and crosslinked homo- and copolymers of maleic anhydride-methyl vinyl ether,

all weight percentages being based on the total weight of the ink composition, the ink composition having a viscosity in a range of 30 to 6000 mPas, measured at 20° C.

The non-waterborne ink composition of the present invention confers a soft feel of writing, remains writable without cap for a prolonged period, does not form drops at the tip and provides a waterfast script.

It is also notable in this connection that the writing inks of the present invention exhibit essentially no viscoelasticity.

For the purposes of the present invention, a nonaqueous polar ink composition includes essentially no or only minimal amounts, i.e. 0% to not more than 8% by weight, preferably 0% to not more than 5% by weight and more preferably 0% to not more than 3% by weight of water as solvent. In other words, the nonaqueous polar ink composition of the present invention is solventborne.

One way to obtain a waterfast ink which does not dry out at the tip after a prolonged period is to use water-insoluble dyes and sparingly volatile solvents. However, such an ink will form droplets at the tip unless thickening fractions such as resins or polymers are included, but even when such thickening fractions are included, but are present in generally dissolved form, i.e. in a completely dissolved state, the degree of droplet formation increases with decreasing viscosity. The size of the droplets which form on tip-down storage can be up to several millimetres.

It has now been determined that, surprisingly, droplet formation at the tip can be avoided if the nonaqueous ink of the present invention includes an insoluble polymer in dispersed form in combination with the specifically selected solvent system. Suitable insoluble polymers are crosslinked homo- or copolymers which will swell to up to 1000 times their original volume in a suitable polar solvent to form a three-dimensional network. Without wishing to be tied to any one theory, we believe that the three-dimensional network formed in this way exerts a retaining power on the ink stored therein and effectively prevents the egress of ink at the tip in the rest state of the ballpoint pen.

Such crosslinked polymers swellable in polar solvents are, in accordance with the present invention, high molecular weight homo- and copolymers of acrylic acid or alkyl acrylates, particularly C₁-C₃₀ alkyl acrylates, crosslinked with polyalkenyl ethers, divinylglycol, allyl ethers of pentaerythrol, allyl ethers of sucrose or allyl ethers of propylene, and crosslinked homo- and copolymers of maleic anhydride-methyl vinyl ether, crosslinked with, for example, diolefins such as 1,9-decadiene. Such crosslinked polymers swellable in polar solvents are available under the trade names of Carbopol, Pemulen, Acritamer and Stabileze. It is preferable to use homo- and copolymers of acrylic acid or alkyl acrylates, in particular C₁-C₃₀ alkyl acrylates, crosslinked with polyalkenyl ethers or divinylglycol.

The use of crosslinked polymers in waterborne inks is described in the literature, as EP 0 717 090 B1 shows by way of example. However, waterborne inks have the disadvantage that the use of water-insoluble dyes is not possible. Water-insoluble dyes are generally soluble in organic solvents that are not too polar. A further disadvantage of such waterborne inks is the risk of drying out at the tip unless the cap has been replaced. However, such aqueous writing fluids, known as “gel inks” are produced using non-crosslinked polymers.

The present invention contemplates the use of 50-98 weight percent of at least one polar solvent selected from the group consisting of glycols, glycol ethers, alcohols and mixtures thereof. More particularly, there is preferably contemplated a solvent mixture which is nonaqueous but sufficiently polar to allow crosslinked polymers to swell, but on the other hand not so polar that water-insoluble dyes do not dissolve therein. In one particularly preferred embodiment, such a solvent mixture comprises 60-90 weight percent of one or more glycols and 10-40 weight percent of one or more alcohols and/or glycol ethers, especially those not miscible with water, based on total solvent. Useful glycols include in particular hexylene glycol, propylene glycol and dipropylene glycol or a mixture thereof. Propylene glycol is a preferred polar solvent in the present ink composition in that it combines sufficient swellability for crosslinked polymers and sufficient dissolving properties for many water-insoluble dyes. Examples of an alcohol or glycol ether suitable according to the present invention, in particular those not miscible with water but having particularly good dissolving properties, particularly on use of laked dye salts, are without limitation being applied: 2-phenoxyethanol, benzyl alcohol, α-methylbenzyl alcohol, diethylene glycol monophenyl ether or propylene glycol monophenyl ether. The exact composition of the solvent depends on requirements for the solubility of the colorants used, or to be more precise for the dispersibility of the pigments used, and for the swellability of the crosslinked polymers used, and is readily determinable by one skilled in the art.

The present invention utilizes 1 to 40, preferably 1 to 30 and more preferably 2 to 20 weight percent of at least one water-insoluble colorant. Useful colorants for the purposes of the present invention include dyes, pigments or mixtures thereof. Particularly useful dyes include lakes, such as Solvent Blue 38, Solvent Blue 43, Solvent Red 39, Solvent Black 46, Solvent Yellow 47, without being restricted thereto. Similarly, the use of pigments in finely dispersed form is possible. Examples thereof are Pigment Black 7, Pigment Blue 15.3, Pigment Green 7, Pigment Red 122.

A further feature of the ink composition of the present invention is the soft writing behavior. It is known that the soft writing behavior of a ballpoint pen is essentially controlled by the viscosity of the ink and can be improved by gliding additives such as, for example, oleic acid being included in the ink. Too low in viscosity, and the resulting writing feel may be scratchy; too high in viscosity, and the resulting writing feel may be a retarding one. The viscosity of the present ink composition is determined by the fractions of dyes having a thickening effect and in particular by the fraction of crosslinked polymers and their characteristic properties, such as the degree of crosslinking for example. It is to be noted in this context that crosslinked polymers are sensitive to ions, in particular metal ions. For instance, cationic impurities in the dyes used may lower the viscosity of the mixture. The optimum viscosity of the soft-writing inks described herein can vary with the design of the writing tips used in the range of 30 to 6000 mPas, preferably in the range from 100 to 4000 mPas and more preferably in the range from 100 to 2000 mPas, measured at 20° C. with a Haake Rheostress RS600 using cone C 35/2° at a shear rate of 60 s⁻¹.

The viscosity is preferably fine-tuned in a known manner by neutralization of acidic groups, such as COO⁻ groups, of the crosslinked polymers. Useful neutralizing agents include inorganic or preferably organic bases such as triethanolamine, aminomethylpropanol, triisopropanolamine, typically used in an amount of 0.1% to 3% by weight. To adjust the viscosity the ink may additionally include known writing ink binders and polymers provided they are compatible with the crosslinked polymers and the other ingredients. Similarly, the use of known additives such as corrosion inhibitors, defoamers, complexing agents or cap-off additives is possible.

The present invention is more particularly elucidated by the examples hereinbelow without being restricted thereto.

The inks shown in Tables 1 and 2 hereinbelow were prepared by mixing at 50° C. using a dissolver disc. The inks in Table 2 were prepared by first dispersing the crosslinked polymer in the solvent system at 1800 rpm for about 2 hours. Thereafter, the remaining constituents were added in the order shown in the table and stirred for a further hour or so. To determine ink laydown, polypropylene reservoirs were filled with 133NS/07TC-ES 405 tips from Premec and written on a Hutt writing test machine at room temperature under the following conditions onto Baumgartner test paper: writing speed 9 m/min, paper advance speed 5 cm/min, writing angle 70°, rotation 1 rpm, writing load 100 g. The viscosities were measured using the aforementioned Haake Rheostress RS600 at a shear rate of 60 s⁻¹.

All the inks in Tables 1 and 2 are low in viscosity, write soft, give a waterfast script and can be stored in the uncapped state for a prolonged period. However, they do exhibit significant differences in static leaking upon storage of filled reservoirs in the tip down position. The inks of Comparative Examples A1 to A3, which include two different non-crosslinked polymers, and of Comparative Example A4, which includes no polymer, lead to large droplets at the writing tip, whereas all inventive inks of Inventive Examples B1 to B5, which include a crosslinked polymer, have no droplets at the tip. In Inventive Example B3, a dye-base, C.I. Solvent Blue 4, takes over the function of the neutralizing agent. As the inventive examples further show, particularly the use of crosslinked polymers increases the laydown of the inventive inks, for which complete swelling is induced, by about 25%. This leads to a homogeneous script image and to higher color intensity than for otherwise similar inks which, however, include non-crosslinked polymers, and constitutes a further advantage of the inventive inks; cf. in particular Examples B1 to B5 according to the present invention.

TABLE 1

| | A1 | A2 | A3 | A4 |
|---|---|---|---|---|
| colour of ink | black | black | black | black |
| propylene glycol | | 67 | 66.1 | 68 |
| 2-phenoxyethanol | 41.25 | 8.4 | 8.2 | 8.5 |
| benzyl alcohol | 41.25 | 8.4 | 8.2 | 8.5 |
| Luviskol K90 ²⁾ | 2 | 0.7 | | |
| Mowital B60H ³⁾ | | | 2 | |
| Solvent Black 46 | 15 | 15 | 15 | 15 |
| oleic acid | 0.5 | 0.5 | 0.5 | |
| Total | 100 | 100 | 100 | 100 |
| viscosity mPas/60 s⁻¹ | 380 | 290 | 450 | 90 |
| polymer crosslinked yes/no | n | n | n | NA |
| swelling ⁴⁾ | NA | NA | NA | NA |
| static leaking, mm of | 1.0 | 2.0 | 1.3 | 4 |
| droplets ⁵⁾ | | | | |
| ink laydown mg/100 m | 18.8 | 19 | 20.2 | 18 |

TABLE 2

| | B1 | B2 | B3 | B4 | B5 |
|---|---|---|---|---|---|
| colour of ink | black | blue | blue | red | black |
| propylene glycol | 66.1 | 70.9 | 76.6 | 73.3 | 66.1 |
| 2-phenoxyethanol | 8.3 | 9 | 9.5 | 9.2 | 8.3 |
| benzyl alcohol | 8.3 | 9 | 9.5 | 9.2 | 8.3 |
| Carbopol EDT 2623 ¹⁾ | 0.8 | 0.8 | 0.8 | 0.8 | |
| Pemulen 1622 ¹⁾ | | | | | 0.8 |
| Solvent Black 46 | 15 | | | | 15 |
| Solvent Blue 43 | | 8 | | | |
| Solvent Blue 4 | | | 2 | | |
| Solvent Red 39 | | | | 6 | |
| triethanolamine | 1 | 1.8 | — | 1 | 1 |
| oleic acid | 0.5 | 0.5 | 1.6 | 0.5 | 0.5 |
| total | 100 | 100 | 100 | 100 | 100 |
| colour of ink | black | blue | blue | red | black |
| viscosity mPas/60 s⁻¹ | 380 | 150 | 670 | 120 | 510 |
| polymer crosslinked yes/no | y | y | y | y | y |
| swelling ⁴⁾ | v | v | v | v | v |
| static leaking, mm of | 0 | 0 | 0 | 0 | 0 |
| droplets ⁵⁾ | | | | | |
| ink laydown mg/100 m | 25.3 | 24.6 | 24.7 | 23.2 | 24.2 |

¹⁾ Crosslinked polyacrylic acid from Noveon
²⁾ PVP from BASF
³⁾ PVB from Clariant
⁴⁾ Swelling was judged by visual inspection following addition of the crosslinked polymer but before addition of the dye. The mixture was transparent when completely swollen, whereas when incompletely swollen it still included many white particles in finely divided form;
NA = not applicable; v = complete
⁵⁾ Reservoirs were filled up to a height of about 10 cm and then stored tip down at room temperature for 20 h before the diameter of the droplets which had emerged at the ball was determined. The reported value corresponds to an average of 3 reservoirs

1. A nonaqeuous polar ink composition comprising
a) 1-40 weight percent of at least one water-insoluble colorant,
b) 50-98 weight percent of at least one polar solvent selected from the group comprising of glycols, glycol ethers, alcohols and mixtures thereof,
c) 0.05-5 weight percent of at least one crosslinked polymer swellable in the polar solvent used, said polymer being selected from the group consisting of homo- and copolymers of acrylic acid or alkyl acrylates, crosslinked with polyalkenyl ethers, divinylglycol, allyl ethers of pentaerythrol, allyl ethers of sucrose or allyl ethers of propylene, and crosslinked homo- and copolymers of maleic anhydride-methyl vinyl ether,
all weight percentages being based on the total weight of the ink composition, and the ink composition having a viscosity in a range of 30 to 6000 mPas, measured at 20° C.

2. The ink composition according to claim 1, including 0.2-1.5 weight percent of at least one crosslinked polymer swellable in the polar solvent used.

3. The ink composition according to claim 1, utilizing homo- and copolymers of acrylic acid or alkyl acrylates crosslinked with polyalkenyl ethers or divinylglycol as swellable crosslinked polymer.

4. The ink composition according to claims 1, utilizing a polar solvent mixture of 60-90 weight percent of one or more glycols and 10-40 weight percent of one or more alcohols and/or glycol ethers, especially those not miscible with water, based on total solvent.

5. The ink composition according to claim 4, wherein the glycol is selected from hexylene glycol, propylene glycol or dipropylene glycol.

6. The ink composition according to claim 5, wherein the glycol is propylene glycol.

7. The ink composition according to claims 4, wherein the alcohol or glycol ether is selected from 2-phenoxyethanol, benzyl alcohol, α-methylbenzyl alcohol, diethylene glycol monophenyl ether or propylene glycol monophenyl ether.

8. The ink composition according to claim 1, wherein the colorant is composed of water-insoluble dyes.

9. The ink composition according to claim 8, wherein the water-insoluble dyes are lakes.

10. The ink composition according to claim 1, further including one or more neutralizing agents.

11. The ink composition according to claim 1, further including gliding additives, corrosion inhibitors, complexing agents and/or defoamers.
